(19) United States
(12) Patent Application Publication
(10) Pub. No.: US 2025/0133974 A1
(43) Pub. Date: May 1, 2025

(54) GARDENING DEVICE

(71) Applicant: Reissmann Ventures Inc., Statesville, NC (US)

(72) Inventor: LUTZ REISSMANN, STATESVILLE, NC (US)

(73) Assignee: Reissmann Ventures Inc., Statesville, NC (US)

(21) Appl. No.: 18/499,612

(22) Filed: Nov. 1, 2023

(51) Int. Cl. A01B 1/16

(52) U.S. Cl. CPC A01B 1/16

(57) ABSTRACT

A handheld gardening device that extracts unwanted vegetation, the gardening device includes a unique configuration of a plurality of first tines and a plurality of second tines that extend from a frame connected to a shaft. The first tines extend substantially along a first tine axis that is substantially perpendicular to the frame and the shaft. The first tine axes are oriented on a first plane. The second tines define a first portion and a second portion, wherein the first portion axes are oriented on a first portion plane and the second portion axes are oriented on a second portion plane. The first and second portion planes are substantially parallel to and offset from one other to form a space that wedges the root system between the first and second tines to extract unwanted vegetation. The handheld gardening device may be used in combination with an extended shaft component.

### FIELD OF THE INVENTION

The disclosure herein pertains to gardening equipment generally, and particularly pertains to a handheld gardening device or implement for extracting unwanted vegetation, in particular weeds, and more specifically the roots of such unwanted vegetation without disturbing or harming any proximal flowers, plants, and shrubs that planted nearby.

### DESCRIPTION OF THE PRIOR ART AND OBJECTIVES OF THE INVENTION

Gardening, a beloved pursuit practiced by individuals worldwide, encompasses a diverse range of enthusiasts, from leisurely gardeners to seasoned professionals. While many revel in gardening as a fulfilling hobby, others, such as professional landscapers dedicate their careers to maintaining and enhancing the beauty of various landscapes, whether they adorn university campuses, public spaces, or private residences. Regardless of the scale or purpose of these gardens, their upkeep demands a multifaceted approach, involving tasks such as planting, watering, mulching, pruning, and harvesting. Among these essential tasks, weeding stands out as a labor-intensive and persistent challenge.

Weeds, unwanted vegetation that competes voraciously with cultivated plants for vital resources like nutrients, sunlight, and space, have long vexed gardeners. Effective weed management consumes substantial time and effort, as unchecked weed growth can swiftly diminish the health and aesthetics of a garden. Conventional weed removal methods often rely on manual tools like hoes, shovels, and trowels, which demand physical exertion and meticulous attention. In addition, all the above mentioned methods only loosen the soil around such unwanted vegetation, but still require the user to manually pick it up by hand and discard it. Over time, more mechanized solutions, such as weed whackers and powered cultivators, were introduced to alleviate the physical strain associated with weed removal. However, these existing approaches still harbor inherent limitations, including imprecision, soil disruption, and the occasional collateral damage to desirable plants, leaving room for innovation and improvement in the field of weed removal technology. In fact, these existing approaches may exacerbate the problem by failing to remove the roots of the unwanted vegetation from the soil, allowing it to grow back, quicker and more resilient in a shorter time frame.

It is essential to remove the entire weed, including its roots and off shoots, rather than merely plucking its flowers or visible parts, due to the inherent nature of weeds and their impact on gardens. Weeds are resilient and tenacious plants that have evolved efficient survival mechanisms. By removing only the visible portion of a weed, while leaving the roots intact, the weed can quickly regenerate and continue to compete with desirable plants for resources like water, nutrients, and sunlight. Over time, this persistent competition can weaken and even overtake cultivated plants, leading to reduced yields, stunted growth, and diminished garden aesthetics. Therefore, thorough weed removal, addressing both the above-ground growth and the root system, is crucial to effectively mitigate the ongoing threat posed by weeds and ensure the long-term health and vitality of the garden.

Thus, in view of the problems and disadvantages associated with prior art devices and methods, the present disclosure was conceived and is directed towards a gardening implement that overcomes these pitfalls by disclosing a device that increases precision, reduces soil disturbance, prevents damage to nearby cultivated plants, and ultimately is easier to use by anyone from leisurely gardeners to seasoned professionals.

It is another objective of the present disclosure to provide a handheld gardening device having a plurality of tines configured to wedge weeds between the tines such that the weeds may be fully extracted (i.e., both flowers and roots), and the soil is not inadvertently disturbed.

It is still another objective of the present disclosure to provide a handheld gardening device including a shaft, a plurality of first tines and a plurality of second tines, the plurality of second tines defining first portions and second portions, wherein the second portions define a planar surface parallel to a planar surface defined by the plurality of first tines.

It is a further objective of the present disclosure to provide a gardening device including a plurality of first tines configured to penetrate the soil around unwanted vegetation and a plurality of second tines, each of the second tines configured to force the unwanted vegetation to wedge in a space between the plurality of first tines and the plurality of second tines.

It is still a further objective of the present disclosure to provide a gardening device that wedges unwanted vegetation between adjacent tines so the unwanted vegetation can be extracted from the soil such that tapping a shaft of the gardening device dislodges the unwanted vegetation without the need to manipulate the unwanted vegetation with a hand.

It is yet a further objective of the present disclosure to provide a gardening device that may be used in combination with an extended shaft to allow users who may struggle with mobility to remove and dispose of unwanted vegetation without needing to kneel down or bend over to uproot the unwanted vegetation.

Various other objectives and advantages of the present disclosure will become apparent to those skilled in the art as a more detailed description is set forth below.

### SUMMARY OF THE INVENTION

The aforesaid and other objectives are realized by providing a gardening device for extracting unwanted vegetation, and more specifically the entirety of the unwanted vegetation including the roots and off shoots. The gardening device includes a shaft and a unique configuration of tines meant to wedge the roots of unwanted vegetation between the tines to ensure full extraction of the unwanted vegetation. The gardening device includes a shaft defining a proximal end and a distal end, with a frame member extending laterally from the distal end of the shaft. The shaft is preferably sized and shaped to be easily held by the hand of a user. The unique configuration of tines extend from the frame member and further define a plurality of first tines and a plurality of second tines. In the preferred embodiment, the plurality of first tines and plurality of second tines extend from the frame member in alternating, offset fashion such that a first tine is positioned between two second tines. Each of the plurality of second tines further define a first portion and a second portion, wherein the first portion is substantially situated on a first portion plane and the second portion is substantially situated on a second portion plane, and the first portion plane and the second portion plane intersect proximate a bend point in the second tines. The plurality of first tines extend from the frame and are defined on a first tine axis, the first tine axis is substantially perpendicular to the frame and the shaft. In a preferred embodiment, the first tine plane and the second portion plane are substantially parallel and offset a distance, creating a space to wedge roots.

The plurality of second tines are preferably longer than the plurality of first tines such that the plurality of second tines penetrate the soil first, forcing the roots of the unwanted vegetation to wedge and compress between the tines. The distal tips of each of the second tines are generally cylindrical and narrower than the distal tips of the first tines. The distal tips of the first tines preferably define an arrow or wedge shape to force the roots of the unwanted vegetation to wedge between the space defined by the offset and between the tines. In some embodiments, the distal tips of the first tines define a barb on each side to further entangle and prevent the roots from falling out of the tines during the extraction of the unwanted vegetation.

The overall size and shape of the gardening device is critical to the advantages over the prior art. For this reason, the gardening device is meant to be handheld and large enough to remove a single weed at a time. The small construction of the gardening device ensures that the device is precise so as not to unnecessarily disturb the soil, or cause damage to the nearby plants. Because of the size, the gardening device may be used in combination with an extended shaft component to allow the gardening device to be used without needing to kneel down or bend over to extract the unwanted vegetation.

### BRIEF DESCRIPTION OF THE DRAWINGS

FIG. 1 shows a front perspective view of the gardening device of the present disclosure;

FIG. 2 pictures a rear perspective view of the gardening device of FIG. 1;

FIG. 3 depicts a front elevational view of the gardening device of FIG. 1;

FIG. 4 demonstrates a rear elevational view of the gardening device of FIG. 1;

FIG. 5 illustrates a side elevational view of the gardening device of FIG. 1;

FIG. 6 shows a top plan view of the gardening device of FIG. 1;

FIG. 7 pictures a bottom plan view of the gardening device of FIG. 1;

FIG. 8 depicts a perspective view of an alternate gardening device in combination with an extended shaft component; and

FIG. 9 shows a bottom plan view of another alternate gardening device with barbs.

### DETAILED DESCRIPTION OF THE PREFERRED EMBODIMENT AND OPERATION OF THE INVENTION

Various exemplary embodiments of the present disclosure are described below. Use of the term “exemplary” means illustrative or by way of example only, and any reference herein to “the disclosure” is not intended to restrict or limit the disclosure to exact features or step of any one or more of the exemplary embodiments disclosed in the present specification. References to “exemplary embodiment”, “one embodiment”, “an embodiment”, “various embodiments”, and the like may indicate that the embodiment(s) of the disclosure so described may include a particular feature, structure, or characteristic, but not every embodiment necessarily incudes the particular feature, structure, or characteristic. Further, repeated use of the phrase “in one embodiment”, “in an exemplary embodiment”, or “in an alternative embodiment” do not necessarily refer to the same embodiment, although they may.

It is also noted that terms like “preferably”, “commonly”, and “typically” are not utilized herein to limit the scope of the disclosure or to imply that certain features are critical, essential, or even important to the structure or function of the disclosure. Rather, these terms are merely intended to highlight alternative or additional features that may or may not be utilized in a particular embodiment of the present disclosure.

The present disclosure is described more fully hereinafter with reference to the accompanying figures, in which one or more exemplary embodiments of the disclosure are shown. Like numbers used herein refer to like elements throughout. The disclosure may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limited as to the scope of the disclosure, and any and all equivalents thereof. Moreover, many embodiments such as adaptations, variations, modifications, and equivalent arrangements will be implicitly disclosed by the embodiments described herein and fall within the scope of the instant disclosure.

Although specific terms are employed herein, they are used in a generic and descriptive sense only and not for the purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. Where only one item is intended, the terms “one and only one”, “single”, or similar language is used. When used herein to join a list of items, the term “or” denotes at least one of the items but does not exclude a plurality of items of the list.

In the present disclosure, the term “substantially perpendicular” are defined to encompass a broader range of angular relationships than the strict mathematical definition of ninety degrees (90°). Specifically, the usage of “substantially perpendicular” is intended to signify an angle generally orthogonal to the reference axis while allowing for a variance of plus or minus five degrees (5°). This definition is employed to acknowledge and encompass the practical realities of real-world scenarios, where perfect right angles may not always be achievable or necessary. Therefore, two lines, axes, or planes forming an angle within the range of eighty-five to ninety-five degrees (85-95°) are considered “substantially perpendicular” and are wholly within the scope of the present disclosure, providing a more flexible and applicable interpretation of this critical geometric concept.

Also present in the disclosure, the term or “substantially parallel” are defined to encompass a broader range of angular relationship than the strict mathematical defining of zero degrees (0°) or one hundred eighty degrees (180°). Specifically, the usage of “substantially parallel” is intended to signify an angle generally parallel to the reference axis while allowing for a variance of plus or minus five degrees (5°). The definition is employed to acknowledge and encompass the practical realities of real-world scenarios, where perfect parallel axes or planes may not always be achievable or necessary. Therefore, two lines, axes, or planes forming an angle within the range of zero to five degrees (0-5°) or one hundred seventy-five to one hundred eighty-five degrees (175-185°) are considered “substantially parallel” and are wholly within the scope of the present disclosure, providing a more flexible and applicable interpretation of this critical geometric concept.

For exemplary methods or processes of the disclosure, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present disclosure.

Additionally, any references to advantages, benefits, unexpected results, or operability of the present disclosure are not intended as an affirmation that the disclosure has previously been reduced to practice or that any testing has been performed. Likewise, unless stated otherwise, use of verbs in the past tense (present perfect or preterit) is not intended to indicate or imply that the disclosure has previously been reduced to practice or that any testing has been performed.

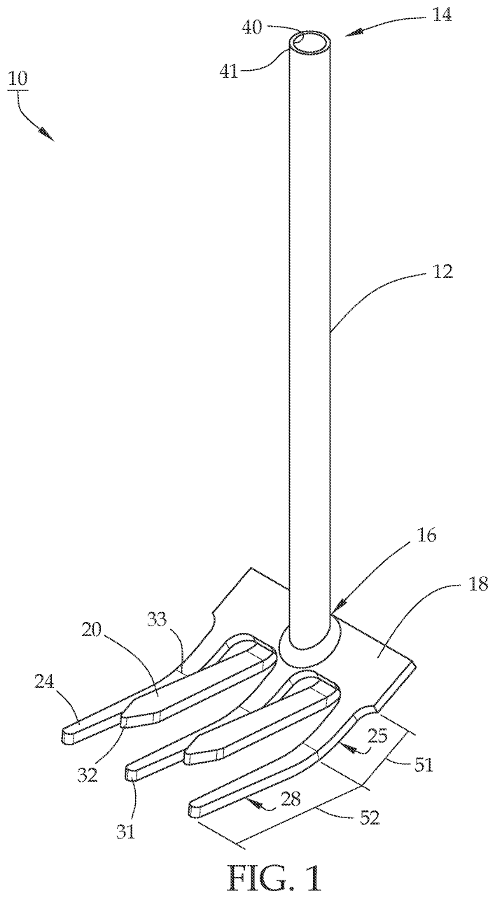

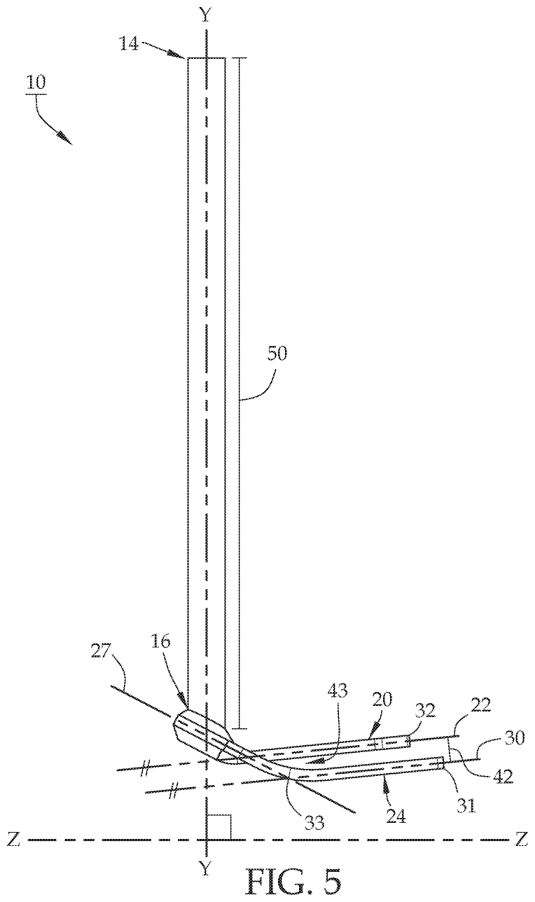

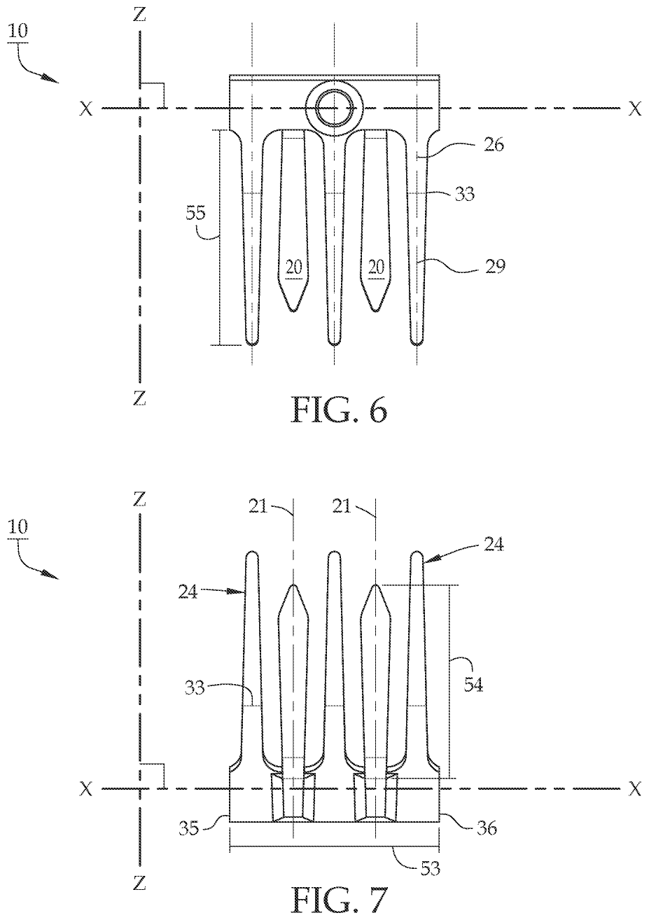

For a better understanding of the disclosure and its operation, turning now to the drawings, FIGS. 1-9 illustrate various views and embodiments of a preferred gardening device as disclosed herein. The gardening device 10 preferably includes a shaft 12, a frame 18, a plurality of first tines 20, and a plurality of second tines 24. The shaft 12 defines a proximal end 14 and a distal end 16. The frame 18 extends laterally from the distal end 16 of the shaft 12, and the shaft 12 is preferably centrally located on the frame 18. The plurality of second tines 24 extend from the frame 18 and each of the second tines 24 define a first portion 25 and a second portion 28. Each of the first portions 25 is substantially defined along a first portion axis 26 (FIG. 6) and each of the first portion axes 26 are substantially oriented on a first portion plane 27 (FIG. 5). Each of the second portions 28 is substantially defined along a second portion axis 29 (FIG. 6) and each of the second portion axes 29 are substantially oriented on a second portion plane 30 (FIG. 5). In the preferred embodiment the first portion plane 27 and the second portion plane 30 intersect as seen in FIG. 5. The plurality of first tines 20 extend from the frame 18 and each of the first tines 20 is substantially defined along a first tine axis 21 (FIG. 7) and each of the first axes 21 are substantially oriented on a first tine plane 22 (FIG. 5). In the preferred embodiment, first tine plane 22 and the first portion plane 27 intersect, and the first tine plane 22 is substantially parallel and offset a distance 42 to the second portion plane 30 as seen in FIG. 5.

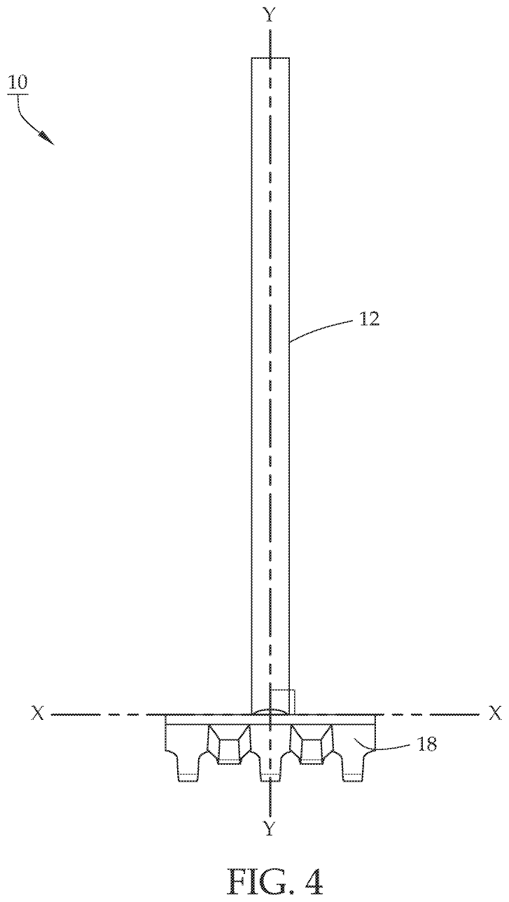

FIG. 1 illustrates a perspective view of a preferred embodiment of the gardening device 10 as disclosed herein. As illustrated in the Figures, the shaft 12 is generally oriented along a vertical axis, represented by line Y-Y as seen in FIGS. 4 and 5. The shaft 12 is illustrated as having a cylindrical cross-section; however, it shall be understood that the shaft 12 may define a number of different cross-sectional shapes, including but not limited to, oval, rectangular, triangular, or any other polygonal shape. The shaft 12 defines a length 50 between the proximal end 14 and the distal end 16. The length 50 of the shaft 12 is preferably between five inches to twelve inches (5″-12″), and most preferably is about seven inches (7″). The shaft 12 may define a hollow center further defining an inner diameter 40 and an outer diameter 41. The outer diameter 41 is preferably between a quarter inch (0.25″) and one inch (1.0″), and most preferably is about a half inch (0.5″) (+/−0.1 inch). The inner diameter 40 is preferably between an eighth of an inch (0.125″) and a half inch (0.5″), and most preferably is about five sixteenths of an inch (0.3125″) (+/−0.1 inch). The length 50 and the outer diameter 41 of the shaft 12 are critical to the disclosure because the present disclosure is preferably used as a handheld device for removing a single weed at a time and therefore a device that is too heavy, too large, or too difficult to manipulate, detracts from the purpose of this disclosure, as will be described in further detail herein.

As illustrated in FIG. 1, each of the first portions 25 are defined as the portion of the second tine 24 that extend from the frame 18 to a point 33 at which the second tine 24 bends. Each of the second portions 28 are defined as the portion of the second tine 24 that extend from the point 33 at which the second tine 24 bends to a distal tip 31 of the second tine 24. In the preferred embodiment, as shown in the Figures, each of the first portions 25 are substantially defined along first portion axes 26, and each of the first portion axes 26 are substantially oriented on the first portion plane 27. Also illustrated in the Figures, in the preferred embodiment, each of the second portions 28 are substantially defined along second portion axes 29, and each of the second portion axes 29 are substantially oriented on a second portion plane 30. In a preferred embodiment, each of the first tines 20 extend from the frame 18 to a distal tip 32 of the first tine 20, each of the first tines 20 are substantially defined along a first tine axis 21, and each of the first axes 21 are substantially oriented on a first tine plane 22. In the preferred embodiment the first portion 25 defines a length 51 measured from the frame 18 to the bend point 33 and ideally ranges from three quarters of an inch to one and a half inches (0.750″-1.50″), and in the most preferred embodiment is about one inch (1.0″). The second portion 28 defines a length 52 measured from the bend point 33 to the distal tip 31 and ideally ranges from one inch to two inches (1.0″-2.0″), and in the most preferred embodiment is about one and a half inches (1.50″).

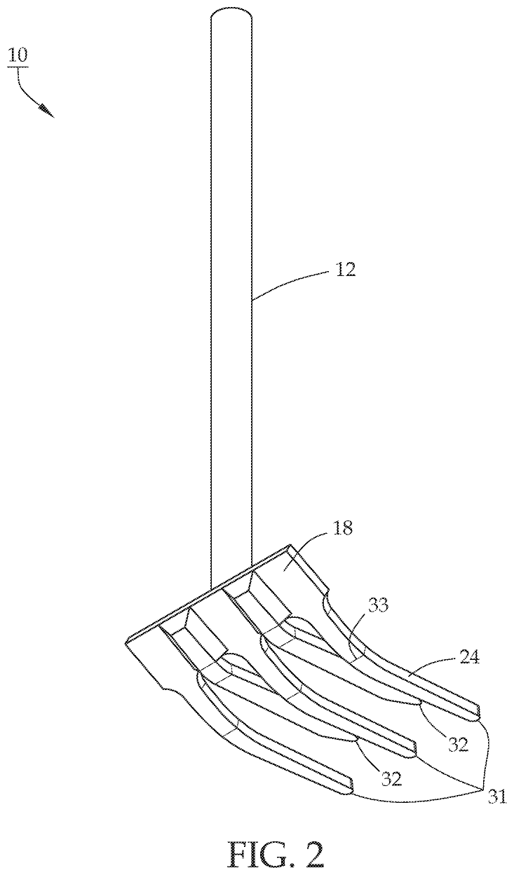

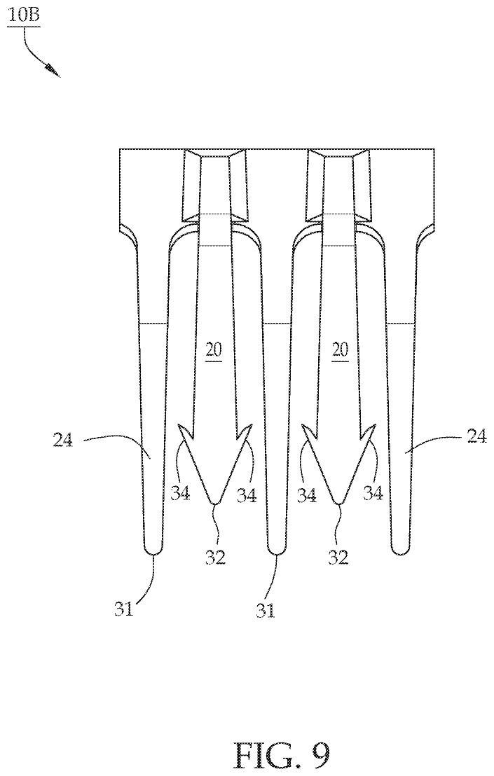

As illustrated in FIG. 2, each of the plurality of first tines 20 defines a distal tip 32 and each of the plurality of second tines 24 defines a distal tip 31. In the preferred embodiment, as shown in the Figures, the length 51 of the first portion 25, the length 52 of the second portion 28, and the distal tip 31 of each second tine 24 generally define the same or similar cross-sectional shape. Stated differently, the thickness and the width of the second tines 24 are generally the same and may range from an eighth of an inch to a quarter inch (0.125″-0.25″). In other embodiments the length 51 of the first portion 25, the length 52 of the second portion 28, and the distal tip 31 of each second tine 24 are not generally the same dimension; instead, the dimensions of the second tines 24 gradually increase, with the narrowest portion being the distal tip 31 and the widest portion being proximate the frame member 18. In the preferred embodiment, the distal tips 32 of the first tines 20 are typically wider than the distal tips 31 of the second tines 24. Unlike the distal tips 31 of the second tines 24, which are typically more cylindrical and rounded, the distal tips 32 of the first tines 20 are typically wider. In the preferred embodiment, the distal tips 31 of the first tines 20 are pointed, such that they resemble the shape of an arrowhead or wedge. In one or more embodiments, such as shown in FIG. 9, the distal tip 32 of one or more first tines 20 includes a barb 34. The barb 34 is preferably formed on the sides 37 of the first tine 20. The barb 34 is defined as a sharp projection extending backwards from the distal tip 32 (i.e., towards the frame 18) for the purpose of preventing unwanted removal of the vegetation being extracted from the gardening device. The barb 34 is intended to ensure that the unwanted vegetation is securely wedged and retained between the plurality of tines 20, 24.

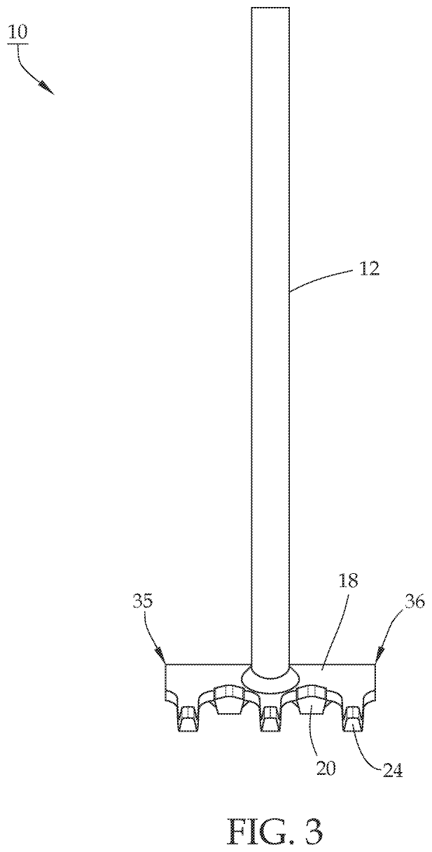

FIGS. 3 and 4 illustrate front and rear elevational views, respectfully, of the gardening device 10 of FIG. 1. As illustrated, the frame member 18 extends laterally from the distal end 16 of the shaft 18, and is substantially defined along a horizontal axis, represented by the line X-X in FIG. 4. The shaft 12 is generally defined along a vertical axis, represented by the line Y-Y. Line Y-Y and line X-X are perpendicular to one another. In the preferred embodiment, the frame member 18 defines a width 53 (FIG. 7) between a first end 35 and a second end 36 of the frame 18 as also seen in FIG. 3. Generally speaking, the wider the frame member 18, the more soil will be disturbed while using the gardening device 10 to extract unwanted vegetation. For this reason, the width 53 preferably ranges from one inch to five inches (1.0″-5.0″), and most preferably defines a width of approximately two inches (2.0″) (+/−0.1 inch).

As can be easily seen in the Figures, particularly FIGS. 1, 5, 6, and 7, in the preferred embodiment, the plurality of first tines 20 extend a first tine length 54 (FIG. 7) from the frame 18, the plurality of second tines 24 extend a second tine length 55 (FIG. 6) from the frame 18, and the first tine length 54 is preferably shorter than the second tine length 55. It is preferred that the distal tips 31 of the second tines 24 extend further from the frame 18 than the distal tips 32 of the first tines 20 because during use, the distal tips 31 of the second tines 24 penetrate the ground first. The ground is generally represented as the Z-axis illustrated in FIG. 5. In the preferred embodiment, the first portion plane 27 intersects the first tine plane 22 and the second portion plane 30 at an angle between thirty degrees (30°) and sixty degree (60°), and most preferably at an angle of about forty-five degrees (45°) (+/−2 degrees). The second portion plane 30 and first tine plane 22 are substantially perpendicular to the shaft 12, substantially parallel to each other, and offset a distance 42. The offset distance 42 between the second portion plane 30 and the first tine plane 22 forms a space 43. The space 43 is the area between the bottom side of the first tine 20 and the top side of the second tine 24 near the bend point 33 and proximate the intersection of the first portion plane 27 and the first tine plane 22. The space 43 is large enough to compress the root system of the unwanted vegetation without destroying the root system from the flowering portion. In the preferred embodiment, the offset distance 42 is between about a sixteenth of an inch (0.0625″) to a half inch (0.50″). In the most preferred embodiment, the offset distance 42 is between an eighth of an inch (0.125″) to a quarter of an inch (0.25″).

FIGS. 6 and 7 illustrate respective top and bottom plan views of the gardening device. As illustrated in FIG. 6, when observing the plurality of second tines 24 from the above (i.e., above the X-Z plane) the second tines 24 are all centrally oriented and positioned along axes that are substantially parallel to one another such that the first portion axes 26 and the second portion axes 29, when viewed from above the X-Z plane, are substantially parallel and do not intersect. Likewise, as illustrated in FIG. 7, when observing the plurality of first tines 20 from above (i.e., above the X-Z plane), the first tines 20 are all centrally oriented and positioned along axes that are substantially parallel to one another such that the first axes 21, when viewed from above the X-Z plane, are substantially parallel and do not intersect. Also demonstrated in the preferred embodiment shown in FIGS. 6 and 7, the top and bottom planar surfaces of the first tines 20 are generally larger than the top and bottom planar surfaces of the second tines 24. It is preferred that the top and bottom planar surfaces of the first tines 20 have larger planar surfaces to facilitate lifting of the weeds whereas the second tines 24 are configured narrower to easily penetrate the soil and pass through roots. In the most preferred embodiment, as illustrated in the Figures, the gardening device 10 includes three (3) second tines 24 and two (2) first tines 20. The first tines 20 and second tines 24 are preferably configured in an alternating fashion such that the five (5) tines are arranged in a second tine, first tine, second tine, first tine, second tine pattern along the width 53 of the frame 18.

During use, a user will orient the gardening device 10 such that the first tine plane 22 and the second portion plane 30 are substantially perpendicular to the ground, which may be represented by the Z-axis, as illustrated in FIG. 5. The distal tips 31 of the second tines 24 frictionally scrape the surface such that the second portions 28 of the plurality of second tines 24 are generally positioned just below the soil and root system of the unwanted vegetation. The second tines 24 are meant to be positioned slightly below the soil and just under the flower of the unwanted vegetation. Since the second tines 24 preferably define narrower tines, they are ideal for passing through the root system of the unwanted vegetation. On the other hand, since the first tines 20 preferably define a wider planar top surface, they are ideal for lifting the flower portion of the unwanted vegetation without destroying the unwanted vegetation.

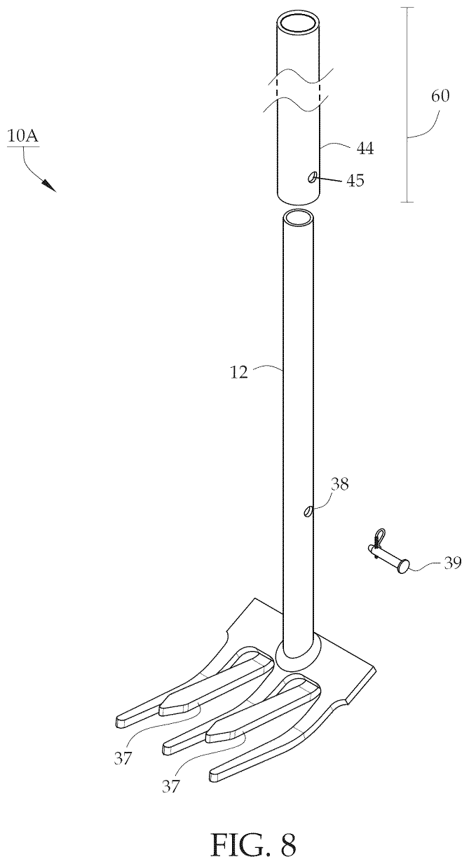

FIG. 8 illustrates a perspective view of a second embodiment of the present disclosure. In a second embodiment, seen by gardening device 10A, the shaft 12 includes one or more apertures 38. In a preferred embodiment, the aperture 38 goes through the entire shaft 12 such that a fastener 39 may be positioned therethrough to secure an extended shaft component 44 to the shaft 12. The fastener 39, as illustrated in FIG. 8, may be a safety pin, or clevis pin, but shall not be limited to such a fastener. In alternative embodiments, the fastener 39 may define a spring button that is positioned within the inner diameter 40 of the shaft 12. The purpose of the fastener 39 is to restrict the axial movement and rotation of the extended shaft component 44 with respect to the shaft 12. The extended shaft component 44 extends the length 50 of the shaft 12 so that a user does not need to bend over to extract unwanted vegetation from the ground. The extended shaft component 44 may be any length between four feet (4′) and six feet (6′). In alternative embodiments, not shown, the shaft 12 may be a telescoping tube that may extend between one to five feet (1-5′).

FIG. 9 demonstrates another alternate embodiment seen by gardening device 10B having a barb 34 positioned on the sides 37 of one or more of the first tines 20. The barb 34 forces the unwanted vegetation between the first and second tines 20, 24, and wedges the unwanted vegetation (typically the root portion of the unwanted vegetation) in the space 43 between the first and second tines 20, 24 to further entangle and prevent the roots from falling out of the tines during extraction of the unwanted vegetation.

The gardening device 10 is preferably manufactured from a metal material such as steel; however, alternative materials may be used without departing from the purpose of the disclosure. The material needs to be strong enough to repeatedly penetrate the ground without bending or causing damage to the tines. The shaft must also be strong enough so as to not bend. The frame 18 is typically welded to the distal end 16 of the shaft 12 and the tines 20, 24 are typically welded to the frame 18. Other methods of manufacturing the gardening device may exist without departing from the purpose of the disclosure.

The illustrations and examples provided herein are for explanatory purposes and are not intended to limit the scope of the appended claims.

1. A gardening device (10) for extracting vegetation with minimal soil disturbance, the device (10) comprising:
a shaft (12) defining a proximal end (14) and a distal end (16), and defined along a Y-axis;
a flat frame (18) connected to the distal end (16) of the shaft (12), and defined along an X-axis;
a plurality of first tines (20) extending from the frame (18) to a distal tip (32), each of the plurality of first tines (20) defined on a first tine axis (21), and each of the first tine axes (21) are oriented on a first tine plane (22);
a plurality of second tines (24), each of the plurality of second tines (18) defining a first portion (25) defined along a first portion axis (26) and a second portion (28) defined along a second portion axis (29), wherein each of the first portions (25) extend from the frame (18) to a point (33) and each of the second portions (28) extend from the point (33) to a distal tip (31), wherein each of the first portion axes (26) are oriented on a first portion plane (27), and wherein each of the second portion axes (29) are oriented on a second portion plane (30); and
wherein the second portion plane (30) is substantially parallel to the first tine plane (22), and wherein the first tine plane (22) is a flat plane.

2. The gardening device (10) of claim 1, wherein each of the first tine axes (21) form a substantially perpendicular angle with the Y-axis and X-axis.

3. The gardening device (10) of claim 1, wherein each of the second portion axes (29) form a substantially perpendicular angle with the Y-axis and X-axis.

4. (canceled)

5. The gardening device (10) of claim 1, wherein the second portion plane (30) and first tine plane (22) are offset a distance (42).

6. The gardening device (10) of claim 5, wherein the distance (42) is between and including a sixteenth of an inch (0.0625″) to a half inch (0.50″).

7. The gardening device (10) of claim 1, wherein each of the first tine axes (21) are substantially parallel to one another.

8. The gardening device (10) of claim 1, wherein each of the first portion axes (26) are substantially parallel to one another.

9. The gardening device (10) of claim 1, wherein each of the second portion axes (29) are substantially parallel to one another.

10. The gardening device (10) of claim 1, wherein the plurality of first tines (20) and the plurality of second tines (24) extend from the frame (18) in alternating fashion such that a first tine (20) of the plurality of first tines (20) is positioned between two second tines (24) of the plurality of second tines (24).

11. The gardening device (10) of claim 10, wherein the plurality of first tines (20) defines two first tines (20) and the plurality of second tines (24) defines three second tines (24).

12. The gardening device (10) of claim 1, wherein the plurality of first tines (20) each extend from the frame (18) and terminate at the distal tip (32) defining a length (54), wherein the plurality of second tines (24) each extend from the frame (18) and terminate at the distal tip (31) defining a length (55), wherein the length (55) of the plurality of second tines (24) is longer than the length (54) of the plurality of first tines (20).

13. The gardening device (10) of claim 12, wherein the distal tip (32) of each of the plurality of first tines (20) defines a larger cross-section than the distal tip (31) of each of the plurality of second tines (24).

14. The gardening device (10) of claim 12, wherein at least one side (37) of at least one of the plurality of first tines (20) includes a barb (34).

15. The gardening device (10) of claim 1, wherein the shaft (12) defines a length (50) between the proximal end (14) and the distal end (16), and the length (50) is between and including five inches to twelve inches.

16. A combination of the gardening device (10) of claim 1 and an extended shaft component (44), the extended shaft component (44) defining a length (60) and a second aperture (45), the second aperture (45) configured to coincide with an aperture (38) of the shaft (12) of the gardening device (10) and configured to receive a fastener (39) to restrict the axial moment and rotation of the extended shaft component (44) with respect to the shaft (12).

17. (canceled)

18. (canceled)

19. (canceled)

20. (canceled)

21. A combination of a gardening device (10) with an extended shaft component (44), the combination comprising:
the garden device (10) including:
a shaft (12) defining a proximal end (14), a distal end (16), and at least one aperture (38), and defined along a Y-axis,
a flat frame (18) connected to the distal end (16) of the shaft (12), and defined along an X-axis, wherein the X-axis is perpendicular to the Y-axis;
a plurality of first tines (20) extending from the frame (18) to a distal tip (32), each of the plurality of first tines (20) defined on a first tine axis (21), each of the first tine axes (21) form a perpendicular angle with the Y-axis and X-axis, and each of the first tine axes (21) are oriented on a first tine plane (22); and
a plurality of second tines (24), each of the plurality of second tines (18) defining a first portion (25) defined along a first portion axis (26) and a second portion (28) defined along a second portion axis (29), wherein each of the first portions (25) extend from the frame (18) to a point (33) and each of the second portions (28) extend from the point (33) to a distal tip (31), the second portion axes (29) form a substantially perpendicular angle with the Y-axis and X-axis, wherein each of the first portion axes (26) are oriented on a first portion plane (27), and each of the second portion axes (29) are oriented on a second portion plane (30); and
an extended shaft component (44) defining a length and a second aperture (45), the second aperture (45) configured to coincide with the aperture (38) of the shaft (12) of the gardening device (10) and configured to receive a fastener (39) to restrict the axial moment and rotation of the extended shaft component (44) with respect to the shaft (12);
wherein the second portion plane (30) is substantially parallel to the first tine plane (22).

22. The combination of claim 21, wherein the length (60) of the extended shaft component (44) is between one foot and six feet.

23. The combination of claim 21, wherein the shaft (12) is a telescoping shaft.

24. The combination of claim 21, wherein the gardening device (10) includes a barb (34) on at least one side (37) of at least one of the plurality of first tines (20).
